(19) United States
(12) Patent Application Publication
(10) Pub. No.: US 2005/0013053 A1
(43) Pub. Date: Jan. 20, 2005

(54) Suspension pitch limiters tandem design

(76) Inventors: Momo Boljanovic, Milipitas, CA (US); Sang Lee, Pleasanton, CA (US)

Correspondence Address: IRELL & MANELLA LLP, 840 NEWPORT CENTER DRIVE, SUITE 400, NEWPORT BEACH, CA, 92660, US

(21) Appl. No.: 10/869,592

(22) Filed: Jun. 15, 2004

Related U.S. Application Data
(60) Provisional application No. 60/488,224, filed on Jul. 16, 2003.

(51) Int. Cl. G11B 5/48

(52) U.S. Cl. 360/245.7

(57) ABSTRACT

A suspension assembly of a hard disk drive. The suspension assembly includes a load beam and a flexure beam. A head is attached to the flexure beam. The flexure beam has a pair of limiters that limit a pitch motion of the flexure beam. The limiters are normally spaced away from the load beam so that the beam can flex during normal operation of the disk drive. During a head slapping event the flexure beam will bend away and then back toward the disk of the drive. The limiters keep the flexure straight so that the head strikes the disk in a flat position. Flat contact between the head and the disk distributes the impact forces throughout all or a portion of the bottom head surface.

### REFERENCE TO CROSS-RELATED APPLICATIONS

This application claims priority to provisional application No. 60/488,224, filed on Jul. 16, 2003.

### BACKGROUND OF THE INVENTION

1. Field of the Invention

The present invention relates to a flexure that minimizes the damage from head slapping.

2. Background Information

Hard disk drives contain a plurality of magnetic heads that are coupled to rotating disks. The heads can magnetize and sense the magnetic fields of the disk to write and read data, respectively. The heads each have an air bearing surface that cooperates with a flow of air generated by the rotating disk to create an air bearing. The air bearing prevents mechanical wear between the head and the disk.

To facilitate formation of the air bearing, the head is typically attached to a gimbal that pivots around a dimple point of a load beam. The load beam is cantilevered from the end of an actuator arm. The actuator arm has a voice coil motor that moves the head across the surfaces of the disks.

A hard disk drive may be subjected to external shock load. Such shock loads can be caused by bumping or dropping a laptop computer. The shock may cause the heads to move away from the disks and then snap back and strike the disk surfaces. Such a phenomenon is commonly referred to as head slapping. Head slapping events can cause damage to both the heads and the disks. The impact forces in a head slapping event are transmitted through the tips of the heads, because the heads normally “fly” at an angle relative to the disk surfaces. In a head slap event, it would be desirable to distribute the impact forces across the bottom surfaces of the heads to reduce local stresses on the disks and heads.

### BRIEF SUMMARY OF THE INVENTION

Disclosed is a suspension assembly of a hard disk drive. The suspension assembly includes a load beam that is coupled to a head and a flexure beam with limiters that limit a bending motion of the first beam.

### BRIEF DESCRIPTION OF THE DRAWINGS

FIG. 1 is a top view of an embodiment of a hard disk drive;

FIG. 2 is a top view showing a suspension assembly;

FIG. 3 is a side view showing the suspension assembly;

FIG. 4 is an enlarged front view of the suspension assembly;

FIG. 5 is a schematic of an electrical circuit for the hard disk drive.

### DETAILED DESCRIPTION

Disclosed is a suspension assembly of a hard disk drive. The suspension assembly includes a load beam and a flexure beam. A head is attached to the gimbal portion of the flexure beam. The flexure beam has a pair of limiters that limit a pitch motion of the flexure beam. The limiters are normally spaced away from the load beam so that the beam can flex during normal operation of the disk drive. During a head slapping event the flexure beam will bend away and then back toward the disk of the drive. The limiters keep the flexure straight so that the head strikes the disk in a flat position. Flat contact between the head and the disk distributes the impact forces throughout all or a portion of the bottom head surface.

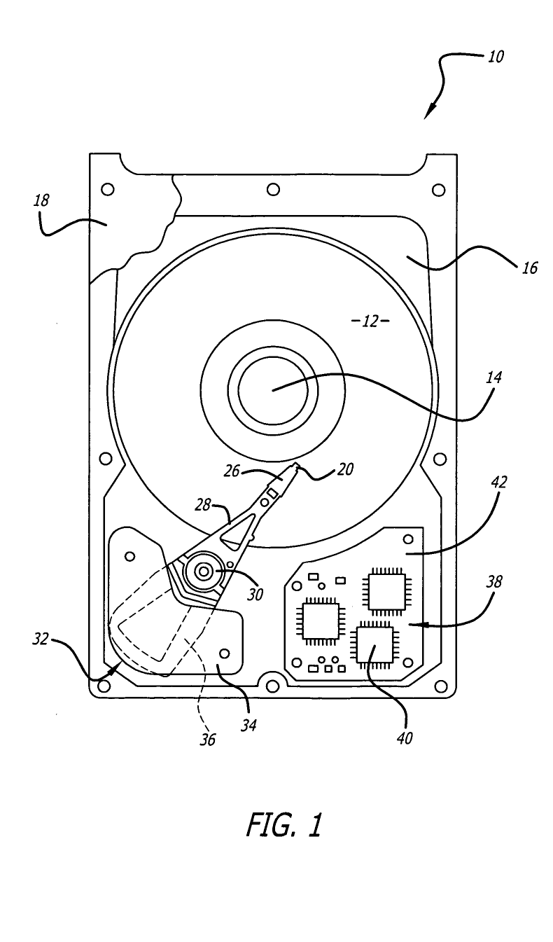

Referring to the drawings more particularly by reference numbers, FIG. 1 shows an embodiment of a hard disk drive 10 of the present invention. The disk drive 10 may include one or more magnetic disks 12 that are rotated by a spindle motor 14. The spindle motor 14 may be mounted to a base plate 16. The disk drive 10 may further have a cover 18 that encloses the disks 12.

The disk drive 10 may include a plurality of heads 20 located adjacent to the disks 12. Each head 20 may have separate write (not shown) and read elements (not shown). The heads 20 are gimbal mounted to a corresponding suspension assembly 26 as part of a head gimbal assembly (HGA). The suspension assemblies 26 are attached to an actuator arm 28 that is pivotally mounted to the base plate 16 by a bearing assembly 30. A voice coil 32 is attached to the actuator arm 28. The voice coil 32 is coupled to a magnet assembly 34 to create a voice coil motor (VCM) 36. Providing a current to the voice coil 32 will create a torque that swings the actuator arm 28 and moves the heads 20 across the disks 12.

The hard disk drive 10 may include a printed circuit board assembly 38 that includes a plurality of integrated circuits 40 coupled to a printed circuit board 42. The printed circuit board 42 is coupled to the voice coil 32, heads 20 and spindle motor 14.

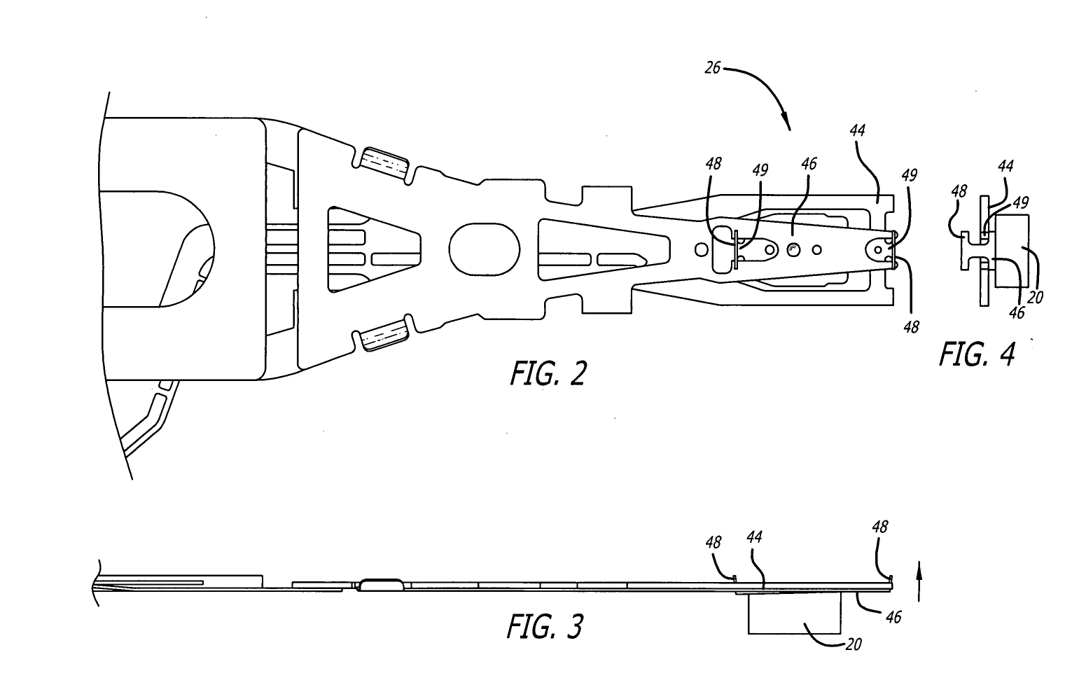

FIGS. 2, 3 and 4 show a suspension assembly 26 (not shown) that has a flexure beam 44 and a load beam 46. A head 20 is attached to a gimbal of the flexure beam 44. The flexure beam 44 has a pair of limiters 48 that extend through corresponding slots 49 of the load beam 46. The limiters 48 may be T-shaped tabs that extend from the flexure beam 44 and under normal operation of the disk drive are spaced from the load beam 46.

When the drive is subjected to a shock the flexure beam 44 may move away from the adjacent disk (not shown) in the direction indicated by the arrow in FIG. 3. The flexure beam 44 engages the limiters 48. The limiters 48 keep the distal portion of the beam 44 straight. When the beam 44 returns back to the disk the limiters 48 maintain the flatness of the flexure beam distal portion so that the head is flush with the disk surface upon contact. Having the head flush or flat with the disk distributes the impact forces along the button surface of the head. Distributing forces reduces local stresses and damage to both the head and the disk.

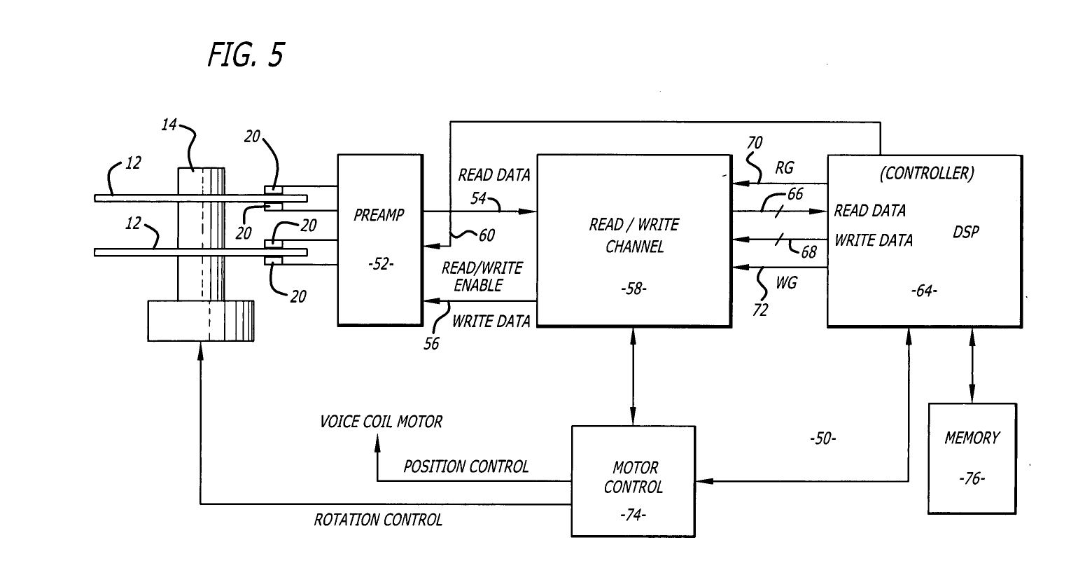

FIG. 5 shows an electrical circuit 50 for reading and writing data onto the disks 12. The circuit 50 may include a pre-amplifier circuit 52 that is coupled to the heads 20. The pre-amplifier circuit 52 has a read data channel 54 and a write data channel 56 that are connected to a read/write channel circuit 58. The pre-amplifier 52 also has a read/write enable gate 60 connected to a controller 64. Data can be written onto the disks 12, or read from the disks 12 by enabling the read/write enable gate 60.

The read/write channel circuit 58 is connected to a controller 64 through read and write channels 66 and 68, respectively, and read and write gates 70 and 72, respectively. The read gate 70 is enabled when data is to be read from the disks 12. The write gate 72 is to be enabled when writing data to the disks 12. The controller 64 may be a digital signal processor that operates in accordance with a firmware and/or software routine(s), including a routine(s) to write and read data from the disks 12. The read/write channel circuit 58 and controller 64 may also be connected to a motor control circuit 74 which controls the voice coil motor 36 and spindle motor 14 of the disk drive 10. The controller 64 may be connected to a non-volatile memory device 76. By way of example, the device 76 may be a read only memory (“ROM”). The non-volatile memory 76 may contain the firmware and/or software routine(s) performed by the controller.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

1. A suspension assembly that supports a head of a hard disk drive, comprising:
a load beam; and,
a flexure beam that has a pair of limiters that are operatively coupled to said load beam to limit a pitch motion of said flexure beam.

2. The assembly of claim 1, wherein each limiter is a T-shape tab that extends through a correspond slot of said load beam.

3. The assembly of claim 1, wherein said limiters are spaced apart along a longitudinal axis of said flexure beam.

4. A suspension assembly that supports a head of a hard disk drive, comprising:
a load beam; and,
a flexure beam with limiter means for limiting a pitch motion of said flexure beam.

5. The assembly of claim 4, wherein said limiter means includes a pair of T-shape tabs that extend through a pair of correspond slots of said load beam.

6. The assembly of claim 5, wherein said T-shaped tabs are spaced apart along a longitudinal axis of said flexure beam.

7. A hard disk drive, comprising:
a base plate;
a spindle motor coupled to said base plate;
a disk coupled to said spindle motor;
an actuator arm coupled to said base plate;
a suspension assembly attached to said actuator arm, said suspension assembly including a load beam, and a flexure beam that has a pair of limiters that are operatively coupled to said load beam to limit a pitch motion of said load beam; and,
a head mounted to said first beam of said flexure beam.

8. The disk drive of claim 7, wherein each limiter is a T-shape tab that extends through a correspond slot of said load beam.

9. The disk drive of claim 7, wherein said limiters are spaced apart along a longitudinal axis of said flexure beam.

10. A hard disk drive, comprising:
a base plate;
a spindle motor coupled to said base plate;
a disk coupled to said spindle motor;
an actuator arm coupled to said base plate;
a suspension assembly attached to said actuator arm, said suspension assembly including a load beam, and a flexure beam that has limiting means for limiting a pitch motion of said flexure beam; and,
a head mounted to said first beam of said suspension assembly.

11. The disk drive of claim 10, wherein said limiter means includes a pair of T-shape tabs that extend through a pair of correspond slots of said load beam.

12. The disk drive of claim 11, wherein said T-shaped tabs are spaced apart along a longitudinal axis of said flexure beam.

13. A method for limiting a pitch motion of a suspension assembly, comprising:
bending a flexure beam of a suspension assembly until a pair of limiters of the flexure beam engage a load beam of the suspension assembly.
